(19) United States
(12) Patent Application Publication
(10) Pub. No.: US 2024/0062258 A1
(43) Pub. Date: Feb. 22, 2024

(54) COMPUTER STORAGE SYSTEM AND METHOD FOR A PLURALITY OF TIMEKEEPING ENTRIES

(71) Applicant: Fulcrum Global Technologies Inc., Chicago, IL (US)

(72) Inventors: Ahmed Farouk SHAABAN, South Barrington, IL (US); Venkat THANDRA, South Barrington, IL (US)

(21) Appl. No.: 18/385,156

(22) Filed: Oct. 30, 2023

Related U.S. Application Data
(63) Continuation of application No. 16/258,607, filed on Jan. 27, 2019, now abandoned.
Application No. 16/258,607 is a continuation of application No. 14/545,345, filed on Apr. 25, 2015, now abandoned.
(60) Provisional application No. 61/998,577, filed on Jun. 30, 2014.

(51) Int. Cl. G06Q 30/04; G09C 1/00; G06Q 10/1091; G06Q 40/10

(52) U.S. Cl. CPC G06Q 30/04; G09C 1/00; G06Q 10/1091; G06Q 40/10

(57) ABSTRACT

The present invention consists of an Improved Time Entry and Recording System and Method, which greatly enhances the features and abilities of such systems in the marketplace. Most notably, it allows the user thereof to create and generate and edit Work in Progress Reports, which may greatly optimize the profitability of any professional firm, and in particular a law firm, by keeping close tabs on all billing entities. In particular, the user may run and directly edit WIP reports and all data found therein in real time. Automatic flagging and comments on every field are provided, as well as user created and defined billing fields.

### CROSS-REFERENCE TO RELATED APPLICATION

The instant application is a continuation of U.S. application Ser. No. 14/545,345 entitled “SYSTEM AND METHOD FOR TIMEKEEPING ENTRY AND WORK IN PROGRESS REPORTS” and filed Apr. 25, 2015, which prior application claims the benefit of U.S. provisional application Ser. No. 61/998,577 filed Jun. 30, 2014, the teachings of which prior applications are incorporated herein by this reference.

### FIELD

The present invention relates to the field of timekeeping and bill generation systems and methods for professionals, most notably those in the areas of attorneys, CPA's (certified public accountants), architects and others who must keep track of data, including, but not limited to: client, matter, description of time spent, hour portions of time spent, flat fee arrangements and total billable hours per worker.

### BACKGROUND

Currently, in the marketplace, there are available a wide variety of different systems and methods for billing professionals to enter time, have pre-bills and then final bills automatically generated on a monthly or other periodic basis, and then have the bill automatically generated and formatted for transmitting a bill to a client who has contracted for services by the hour or by a flat rate. Some of these exemplary systems and methods in the prior art are shown below.

In U.S. Pat. No. 5,991,742 is disclosed a system and method for time and expense logging system. The disclosure includes a timer connected to a microprocessor to identify and store the time activities performed and can be suspended for non-billable interruptions. The computer system also integrates the time and billing system with an address book, an appointment book, a to-do list, and a memo-writing program so that the client and matter information are shared among applications, which can aide in preventing duplicate data entry. This system allows a number of reports to be generated, allowing the user to keep track of billing time related bills and non-time related costs for multiple clients. Further, the data is in a format that can be imported into the accounting and billing system. This method is unlike the present invention, because the present invention adds to the prior art in several areas, including the inventive features of providing automatic translations, an audit-editing feature and will process with multiple tax rates.

In U.S. Pat. No. 6,832,176 B2 is disclosed a system and method for tracking and reporting time spent on tasks. This disclosure consists of a timekeeping software application that is on the end users computer(s) and is able to automatically track time spent by end users in different applications while performing tasks on the end user computers. In some embodiments, the time keeping application is integrated with some of the other applications on the end user computers. This integration allows for the time keeping application to detect and track events such as the opening and closing of files that can represent the start and stop time in the task being performed by the end users. The disclosure also allows the time keeping software to automatically suggest task categorization; for instance, when a file is being processed by an application, the content of the document may be used to categorize. This method is unlike the present invention, because the present invention adds to the prior art in several areas, including the inventive features of providing the display of a plurality of currencies, plurality of billing rates, and a plurality of tax rates, automatic translation of at data entry summaries into at least one additional foreign language.

In U.S. Pat. No. 6,625,267 B1 the prior art discloses a billing system that includes a telephone, printing device, postage applicator, and a computer-based device. The method consists of a system in which the first computer-based device can detect when one of the telephone, printing device, or postage applicator is initiated for use. The billing software application associated with the computer-based device enables logging of client data, service provider data, time and other fields. Also, there can be another second computer that can be connected with the first for remote operation associated with the first computer-based device. This method is unlike the present invention, because the present invention adds to the prior art in several areas, including the inventive features of providing the display of a plurality of currencies, plurality of billing rates, and a plurality of tax rates.

Also, in U.S. Pat. No. 6,735,574 B2, the prior art discloses a method and system for tracking employee productivity, including time in a technical support specialist call center using a client/server configuration. The disclosure provides for a productivity tracking system, which comprises of both a client component and a server component. The client component, at each representatives' computer, provides data entry fields that allow the representative to record productivity information including start and end times of activities. The server component receives productivity information from several client computers and stores the information in a central database. This method is unlike the present invention, because the present invention adds to the prior art in several areas, including the inventive features of providing the ability to generate a Data Entry Listing of more than one Work Data Summary, wherein the User may directly edit at least one of the following data directly from the Data Entry Listing: client name, matter name, hours worked and the description.

In U.S. Pat. No. 7,664,638 B2 is disclosed a system for tracking time by using portable recorders and speech recognition. It converts speech to text, analyzes the text, and determines voice commands and times when the voice commands occurred. There can be task names associated with voice commands and time segments. These time segments and tasks may be packaged and stored for further processing. In U.S. Pat. No. 7,218,980 B1 is disclosed a work-in-progress (WIP) tracking system is used to coordinate a semiconductor supply chain operation. An embodiment of the prior art provides the WIP tracking report as a customer delivery schedule. Another WIP tracking report states the status of an order in process as WIP. The disclosure consists of WIP as a tracking report of various vendors' performance. One embodiment of the WIP tracking system performs consistency checking of WIP updates to detect and prevent missing or misleading WIP updates, thus increasing the accuracy of the data representation.

With prior art systems a plurality of billing systems would exist throughout the nation and the world. Consolidation of information was time consuming and difficult, especially at the end of the month for required financial reports. Numerous servers mean more computer systems to maintain and more computer technicians on staff.

With prior technology, accounting systems could vary from region to region, and all accounting had to be consolidated manually. In addition, various countries around the globe had varying statutory and trust requirements, all of which had to be dealt with on a manual basis and were not consolidated into one uniform timekeeping and billing system. And finally, there was no automated system for handling joint bills and multi-player accounts.

Accordingly, nowhere in the prior art is seen an improved time entry and billing system with the following inventive features: automatic translation of narratives into one or more languages, the ability to edit WIP or time entry listings in real time, the ability to mark fields and split slips, the ability to mark fields and combine slips, the ability to secure the system from unauthorized users by providing security levels to those accessing different portions of client data; the ability to automatically track edits of fields in any given slip or Work Data summary; the ability to transfer work data to a master data base serving work centers across the nation and even the world and further, the ability to enter and assess one or more tax rates against the matters billed to a client.

### SUMMARY

The present invention consists of an improved system and method for entering time and managing pre bills, which are commonly referred to in the trade as “WIP sheets” or Work in Progress Sheets or Work Data summary listings or Data Summary listings. In the professional billing software marketplace, typically a billing entity or “timekeeper” will be assigned a code or descriptor to keep track of what person worked on each client matter. Typically, law firms keep track of timekeepers or billing entities according to their initials such as JMD, KTP, GSW, etc. and then one or more rates are assigned to this timekeeper as contractually agreed upon by the client of the billing entity. In most professional firms, it is important to keep track of the timekeeper who brought the client to the firm so that profits from the client are properly attributed to the client originator. Next, it is important to keep track of all timekeepers or associate attorneys, architects and engineers who worked on each matter for every client according to a predetermined set of rules.

It is extremely important to have pre-determined sets of rules and algorithms for every client, every timekeeper or billing entity, for every client originator which may be scrutinized by others, such as the ABA or American Bar Association, the Association of CPA's etc. so that the software can be accredited and safely used by the relevant professionals in the marketplace to prevent claims of malpractice or other injuries to the public utilizing such services.

Software that is reliable, readily understood, with appropriate algorithms and methods therefore is of utmost importance in its design and usage in the relevant fields or marketplace.

While the software described herein is directed primarily to the legal timekeeping and billing marketplace, it should be understood that the concepts, algorithms and concepts employed herein are readily implemented and adapted to any professional or even nonprofessional purposes to produce accurate bills in a wide variety of circumstances.

The Present Inventive System is used by Timekeepers to record their Time into Timeslips or Work Data Summaries they have worked on for a given Matter or Phase for a particular client. Timekeepers will record their Time in a Work Data System generating Listings for review where the Time is validated and/or approved and closed, which then sends the Work Data Summary to ERP or a Master data base in one preferred embodiment. Once in ERP, the Work Data Summaries are ready to be edited via real time WIP editing.

After Work Data Summaries have been loaded into ERP, a reconciliation process is executed to confirm that all the Work Data Summaries transferred from the Time Work Data System has been loaded properly into ERP. There is a separate error handling processing feature in ERP to review, correct, and reprocess all Timeslips and flagging any errors. A clear audit trail is maintained on all Work Data Entry Summaries that are entered which are input to ERP to enable them to be traced directed back to the Time Entry System.

In one preferred embodiment of the present invention, the present invention, Improved Time Entry Data and Billing system will easily interface with the following data: work date, timekeeper, client, matter, phase, work location, physical work location, legal field, hours (in tenths, minutes or quarter hours), activity, task, flat fee, and a detailed narrative. In addition, there will be a comments field provided which may be uploaded to ERP or a master database. In actual usage, when a timekeeper or billing entity has provided some work to the client on a particular matter on a particular date, she or he will then enter the following information into the Improved Billing and Timekeeping System: timekeeper ID, client ID, matter, phase of work, task, activity, flat fee, area of law and physical work location.

The present inventive system will have the features and advantages of being able to record the time involved on both local and global (non local matters). In addition, it will keep track of non-billing entities that have a responsibility for entering and maintaining time keeping information for billing entities for any particular client and matter. The system will further be provided with security checks and balances where certain deletions may not be possible, or they may be recorded for later review. In some cases, large entries of time to a particular client may be routed to management for review. The system will be provided with real time flags to ensure the integrity of data entered into the Improved System.

The Improved System will further be able to generate real time or periodic reports which can reconcile timekeeping records to some or all of the following data bases: ERP, Master Data Records, end of month captures, large variations in errors and miscalculations; etc. The user will also be able to create additional fields, as desired, for special clients and cases that require additional data storage, either by convenience or pursuant to court order or statute. The system will also be able to create levels of confidentiality and security according to location, type of personnel (staff, attorney, paralegal, para-lawyer, etc.) The Improved System will also be able to display certain fields and not others according to the security level of the viewer of the system, which has been predetermined by a set of algorithms inherent to the Improved System.

The Improved System may also be provided with a Project Delegator that may control certain activities of timekeeping and billing, but not others. The Improved System will be able to capture unknown discrete elements of data (UDF's) for office use or other reporting purposes.

In addition, the detailed Time Narratives will be able to be translated, as desired, by the user or viewer of the Improved System into one or more foreign languages, as desired by the user thereof.

As data is entered by a Timekeeper or assistant to a Timekeeper, the user will be able to quickly determine if any fields are in error such as the Timekeeper name or code, an Activity Name or Code, a Task Name or Code, a billing period name or code, etc. The Improved Timekeeping System will further be able to determine if the Timekeeper has entered time which is in excess of some or all of the predetermined rules: 1) more than an 8 hour work day; 2) more than a preset work day (8 to 12 hours) or 3) more than 24 hours of work in a singular day. The Improved Time Entry System may also be set to exclude or issue warnings when the number of hours billed per week, month or year have exceed a maximum for the user or firm. Utilizing such a system may prevent malpractice and fraud cases for attorney timekeepers who have been limited by statute, client or physical abilities to perform the time entered.

The Present Inventive Time Entry System can also quickly determine if certain Timekeepers are ill, not working up to par, are absent from their workplace or are in need of assistance or it may make further inquiry as to why a timekeeper's work time is not up to expected standards. Many companies require time to be promptly entered, generally in real time, or within 24 hours after and this would provide a system to determine if any billing entity is not entering time promptly and to provoke automatic inquiries by the Improved Time Management System.

In addition, as the Timekeeper enters her or his time, the Improved System may be able to automatically correct for spelling and grammar errors. If these errors occur too frequently, the user of the system may be directed to a program that will clarify spelling or grammar errors for further reference so the problem does not recur with the Timekeeper.

As an additional feature, the Improved System will be able to perform one or more of the following tasks automatically and seamlessly to the user: transfer time and cost entries to another matter; divide time and cost between matters; combine time entries based upon the Timekeeper and the work date involved according to a set of predetermined rules, and then be able to adjust any time values and/or cost entries which were recorded in error according to a predetermined set of rules and algorithms.

In the present Inventive System, the user will be provided with a WIP or Work in Progress Editor or Work Data Summary Listing Editor. The WIP Editor will permit the user to perform one or more of the following tasks: edit the narrative of the description; spell check; transfer time entries or cost entries from one matter to another; split time and cost entries among multiple entries; edit the task or activity codes among multiple entries; edit the task and activity code; alter narratives posted in error and consolidate multiple entries and line items into a single entry made on a single date.

In addition, the WIP or Work Data Summary editor will allow the user to transfer time from one office or location to another. It will further allow for translations of foreign languages quickly and seamlessly. The WIP editor may be run at periodic dates (month end or beginning, mid-month, etc.) or as desired by the user, staff or management on demand and in real time. The Improved System will also allow the user to print a hard copy for annotation or send a soft copy for editing electronically with a viewer and e-post-its, text highlighting and e-typeovers. The improved WIP editor will allow on demand changes of any fields desired by the user of the system, including, but not limited to: matter name, work date, release date, timekeeper name or code, hours worked, hourly rate, activity code, task code, flat fee information, cost and quantity desired.

The WIP editor will have the ability to display the billed amount in plurality of currencies, including, but not limited to: group (USD) currency, local or statutory currency and billing matter currency, as desired, by the user thereof, and in real time or near real time. In addition, an interface will be provided so that a set of local Work Data Summaries each consisting of: Timekeeper (full name, timekeeper number, timekeeper title), Client (client number and client name), Matter (matter name and matter number), Phase Number and Name, Task Codes and Description, Activity Codes and Description, Flat Fee Codes and Description, Area of Law list and Description, and, Physical Work Location (Name and Code) may be transferred to a global set of Master Data at a desired interval or frequency. In addition, the Present Inventive System also has the ability to record time for non-local Timekeepers, as well as local Timekeepers, and it can also allow assistants and other non-Timekeepers to enter time for Timekeepers. An additional feature of one preferred embodiment is the ability of present inventive system to be able to import and export local work time data summaries and other information from region to another.

Another important feature of the Present Inventive system is the following: upon entry, the data will be immediately analyzed for common errors and mistakes and these can be auto-corrected or a warning sound or flag is then generated by the System. The Present Inventive system may record time as desired by the user in common increments such as hour and minute (e.g., 1:15 for an hour and fifteen minutes), or it can enter time in decimals (1.25 for one hour fifteen minutes), or it can enter time in tenths of an hour. The System will also allow the user to undo time as desired. It is possible for the System to track errors and corrections to ensure that time is not frequently diminished or overstated by a particular user(s). An automated auditing trail is a further important feature of the Inventive System.

The Present Inventive System will allow the User thereof to print out WIP or Time Work Data Summary sheets in a wide variety of formats and, while standard report formats will be provided, a wide variety of customized formats will also be provided to the User thereof.

In addition, the User will be able to edit narrative line items for time and cost; spell check for narratives of line items with time and transfer one or more time entries or time entries to from a first Matter to a second Matter, including all time, whether billable or non billable. The User will also be able to adjust any narratives posted in error for time and cost corrections and the User will be able to consolidate the line items of time for the same Timekeeper on the same date into a single Slip.

The Present Inventive System will also allow the User thereof the ability to present the WIP report details or Work Data Summary Listing on a live screen to the Billing Partner and provide a method for the User to include comments and provide further instructions to a Billing Partner.

The present Inventive System will also allow the User to print a hard copy of any WIP or Work Data Summary Listing report generated for annotation thereto and the System will also allow the User to send a soft copy of any WIP report for editing to others in the company or firm.

In general, the present Inventive System will allow the User to display standard WIP valuation reports with standard rates and client values wherein the client values can be based upon client exception rates, where desired.

The present Inventive System will allow the User thereof to value a WIP sheet entry or report in a plurality of currencies. In one preferred embodiment of the Present Inventive System, the System will display the value to client in three currencies: group currency; statutory or local currency and billing matter currency.

The Present Invention System will be provided with a variety of password features such that the narratives will remain private and confidential except to the billing partner and those who are on a need to know basis for the client and client matter in question.

A Billing Coordinator role may also be included in one preferred embodiment of the present invention wherein the ability to limit the WIP or Work Data Summary Listing editing process of the Billing Coordination is restricted to the office level to which the Billing Coordinator has been assigned.

There will further be provided an ability to allow a WIP or Work Data Summary Listing editing process for all offices in agreement with a shared service center arrangement. In addition, there will be provided a tracking method to ensure that the WIP editing process within offices and among shared offices will have an audit trail.

A conversion mechanism will further be provided for the following issues: time and cost slips not billed; time slips with a negative value; time slips with zero hours; time slips with more than 24 hours per day; time and cost slips will be loadable in a standard format.

Further features provided in a preferred embodiment of the present invention include, but are limited to: the ability to return a WIP or Work Data Summary Listing to its working or originating office; the ability to generate a WIP report or Work Data Summary Listing that displays worked hours and worked values together with billed hours and values. The present inventive system will also allow for mass editing, or the ability to view and edit multiple slips or time records at the same time throughout the WIP editing process.

The Present Inventive System will also allow the User thereof to modify hard costs and transfer these from one client matter to another, or to a different client entirely.

The Present Inventive System will allow for a plurality of WIP or Work Data Summary Listing type reports, including by not limited to those generated by one or more of the following selection criteria: Company Code, Office, Partner Function, Practice Group, Client, Matter, Matter Type, Timekeeper, and Group Billing ID. When the present inventive System is in operation, any client write offs may be charged to a cost center as a direct expense against the Billing Attorney for the matter. When any costs are transferred from a billable to a non-billable matter, the associated general ledger posting then moves the cost from the balance sheet account to an expense account.

In one preferred embodiment of the present invention, a three way matching method is used from Purchase to Pay. When this method is utilized, the WIP is recorded when the goods and/or services are delivered to and received by the client.

The Present Inventive System allows the User thereof to spell check an entire WIP report at a single time. The System will also automatically validate task codes and check them to a task code list in real time and transfer costs between matters, as desired during the WIP edit or review process. The User will also be able to choose a valid task code from a list during the WIP editing or review process, when there is a client matter to client matter transfer process.

During actual use of the improved WIP or Work Data Summary Listing editing and processing System, a Billing Coordinator will generate a WIP report in ERP or another operating system commonly available in the relevant marketplace, listing the required matters or reviews for the particular scheduled WIP report. Next, a Billing Coordinator will review the WIP report and will make a decision on whether WIP adjustments are required or not, then she or he will make any necessary edits to the WIP line items in ERP. Finally, the revised WIP report will be sent to the Timekeeper either as an online report, a hard copy or as an email attachment for review and editing by the Timekeeper.

When the Timekeeper receives the WIP or Work Data Summary Listing sheet or attachment, she or he can then make the decision as to whether or not to make additional edits to the WIP sheet and/or Work Data Summaries kept by the Present Inventive System. If there are additional edits, these may be done by the Timekeeper, or the new edits may be passed back to the Billing Coordinator so that the Billing Coordinator or staff may make the edits for the Timekeeper.

For most law firms, businesses charging by the hour such as CPA's, architects and the like, there are various disbursements or soft costs, which must be billed back to a company. Soft costs or disbursements may comprise one or more of the following plurality of items: photocopies, facsimiles, scans, prints, taxi charges, airfare, meals, etc. These disbursements or soft costs are typically tracked by a cost recovery system or time entry system. The files from the cost recovery system are collected and loaded into ERP or the desired operating system at the desired frequency. Costs are created in ERP and then recorded against a specific client Matter or Cost Code and then made available to a WIP or Work in Progress system for viewing and editing. A reconciliation process is available to ensure all Costs or Disbursements from the Cost Recovery System have been transferred into ERP. There will also be a separate error handling process in ERP to reprocess any Soft Costs containing errors. Cost may also be recorded manually in the ERP system. Costs such as photocopies, faxes, scans and prints maybe directed from the firm or company's Xerox machine, copier, copier/scanner, or any other printing machine that has a fiery or onboard computer which has been provided with automated accounting software. In the case of other costs such as travel, hotel, air fare, meals, gas, etc., a Timekeeper or staff may be able to scan in receipts and these will automatically generate a Disbursement Slip or Cost Slip for automatic entry into the system. Receipts which are generated by text or email may also be forwarded by the user for automatic entry into the system.

A reconciliation process is available to ensure all costs form the cost recovery systems have been transferred into ERP. There will also be a separate error handling process in ERP to reprocess any Costs containing errors. Costs may also be recorded manually into ERP.

The system will also allow Costs to be recorded either with or without an associated Task and or Activity Code. In some cases, costs are associated with clients that have not yet been officially retained by the law firm, or the prospective client that has yet to sign a retainer agreement, or the client that has yet to make up her or his mind. Prospective clients may often run up significant Time and Cost charges prior to signing a retainer agreement, or making a decision to formally hire the firm or attorney which they have been calling or visiting.

Cost codes may be recorded in association with one or more of the following data: Date, Timekeeper Name or Number, Client Matter, Task Code, Activity Code, Working Office Location, Cost Code, Amount or Quantity of items(s) and Expensive narrative or detailed description. The Master Data created by the foregoing input may be recorded against one or more of the following: Client Name, Client Number, Matter Name, Matter Number, Matter Description; Timekeeper Name, Timekeeper Number, Activity Types or the soft cost names and codes; Task Codes; Activity Codes and the functional are of the Expense.

The Present Inventive System may also be provided with the ability to import Costs from a cost recovery system into ERP. Non-local offices will be required to provide cost data (including Federal Express, etc.) into a file, which can be handled by the ERP. The Cost Data will be processed in real time or in predetermined batch mode processing at regular or desired intervals.

The Present Inventive System for recording Soft Costs or Disbursements will contain one or more of the following steps: the ability to load Costs into ERP with appropriate validations; the ability to differentiate Soft Costs from Hard Costs; and error processing system will be provided, including a system to identify and re-process records containing data errors; any data errors must be promptly identified and notices created and transmitted promptly to the Timekeeper and Billing Coordinators (preferably once per day) and others interested in system errors for that particular Client or Matter; Error generation may include notifications sent to groups of individuals, as desired. The System must take care to flag and/or eliminate duplicate Costs prior to entry into ERP. An Accounting Clerk or Work Data Clerk may be utilized to post or repost or reprocess costs and handling processes in ERP. A mechanism may also be provided for instances when a zero quantity is entered, the System will automatically generate a value based upon a cost code or activity type of rate. Soft Costs entered should also be classified as taxable or not subject to sales tax. When a cost is received from a non-local office, the tax status of that cost should be set to the same tax status preselected by the main office or billing office.

The Present Inventive System will also allow the User thereof to record Costs directly into ERP manually, as well as load tables in any tabular format, such as Word Excel, WordPerfect Quattro Pro, Open Office and other spread sheet formats, automatically into the System. In addition, the System will accept .txt lists of tabular data in CSV or comma separated values or in a .csv file format. The Present Inventive system will provide storage memory to store reference data for any local or non-local office to use for internal reference.

Further, the Present Inventive System will provide an ERP interface that will take a cost load in its current format and translate it automatically into other formats to make it available for entry into the ERP. The Present Inventive System is designed and configured so that a set of predetermined validations may occur whether Cost Data is provided through an automated data generation process, or though manual data entry. The Present Inventive system will automatically generate a report or ping the Billing Partner whenever errors occur in the data entry, or the quantity has been set to zero.

With the present Inventive System, a plurality of Timekeepers record their Soft Costs to be charged for Matters preselected in the Improved Cost Recovery System. The Timekeeper will note any matters that do not have a valid Client or Matter assigned to the cost, and they cost will be stored against the Timekeeper's general account unless and until the cost is assigned to a valid Client or Matter at a later date. The Timekeeper will review soft costs recorded without a valid Client Matter or Value for the day in question, and release them from further processing in a Billing System.

Next, the Improved Cost Recovery System will generate a batch file of costs and input these into ERP. These cost records will be loaded into ERP and then transferred to WIP. An Accounting Clerk can then verify manually if there are any errors in the upload of the Soft Costs into the ERP, and the errors may be fixed manually and then uploaded again for processing.

These and other alterations and configurations of systems and methods in the timekeeping art which are generally known to those skilled in the art shall be considered as being incorporated into this Summary of the Invention as if set forth fully herein, and should be considered as part of the Present Invention as claimed below.

### OBJECTS OF THE INVENTION

Thus, it is one primary object of the present invention to provide an improved Timekeeping and Recording System which is capable of recording Timeslips or Time Entries containing one or more of the following of a plurality of data: Work Date, Timekeeper Number, Client, Matter, Phase, Work Location, Physical Work Location, Area of Law, Hours, Activity Code, Task Code, Flat Fee Code and a Detailed Description or Narrative in real time and with a predetermined set of values to enhance data collection and processing.

It is yet another primary object of the present invention to provide an Improved Timekeeping and Recording System which is capable of processing Master Data containing Timeslips or Work Data Entries which are processed at both a global and a local basis, and to provide timely WIPs or Work in Process Sheets or Work Data Summary Listings which may be viewed and edited in real time.

A still further primary object of the present invention is to provide an Improved Timekeeping and Recording System which is capable of processing Data Time Summaries into WIP sheets which are capable of displaying time value or hours billing in three rates: a standard rate, a matter rate and an at value rate. A standard rate is the normal rate for the firm, the matter rate is the rate agreed on between the parties, with exceptions, and the at value rate is a discounted rate. Accordingly, the WIP sheet should readily answer the question, “if I were to bill today, what would my charges and/or rate be in total?”

It is further a primary object of the present invention to provide an Improved Timekeeping and Recording System wherein other staff and Timekeepers may input Timeslips from other non-local and local offices for automatic entry into the Improved System and the Time is credited against the Billing Partner's account.

An additional primary object of the present invention is to provide an Improved Timekeeping and Recording System wherein a predetermined set of values are used to review and process any data entry errors into the system which can either be flagged and/or automatically corrected in real time or near real time.

Still a further primary object of the present invention is to provide an Improved Timekeeping and Recording System wherein the User may create and implement User Defined Codes and data fields which are not a part of the standard Timekeeping system which the Inventive System may process and sort on an ad hoc basis.

In addition, a further primary object of the present invention is to provide an Improved Timekeeping and Recording System wherein Time may be recorded in a variety of formats, according to the needs of the user, including Hours in tenths or quarters of an hour; Minutes in whole minutes or decimal portions of an hour, a 24 hour format, and other formats commonly used in billing software.

Still a further primary object of the present invention is to provide an Improved Timekeeping and Recording System wherein the User may correct and amend Timeslips in real time in a WIP, and after a Timeslip batch has been uploaded into ERP for further processing.

Yet a further primary object of the present invention is to provide an Improved Timekeeping and Recording System which is provided with automated error handling and an audit trail for repeated write offs of time, or increases in time after the fact.

An additional primary object of the present invention is to provide an Improved Timekeeping and Recording System, which is provided with a comments field so the User may make notes against any field for himself or others to view by clicking on an icon nearby.

Still a further primary object of the present invention is to provide an Improved Timekeeping and Recording System which may be used by both billing staff (lawyers, paralegals and law clerks) and non billing staff (assistants, secretaries, managers and administrators) alike, and the system will keep track of the entity actually entering the time together with the entity editing any time at a later date.

Yet an additional primary object of the present invention is to provide an Improved Timekeeping and Recording System which is provided with a method for Project Delegators, Managers and Billing Coordinators to run Slip reports (WIP), and other reports, and edit time within the system.

A further primary object of the present invention is to provide an Improved Timekeeping and Recording System, which is provided with security and audit trails for when time is written off by a Timekeeper, Billing Partner or Client Originator.

Still an additional primary object of the present invention is to provide an Improved Timekeeping and Recording System which is provided with automated error flags which are customizable and which alert the User thereof to situations where Time is zero, the Quantity in a Disbursement Slip is zero, the Description is missing or too short, etc.

Yet a further primary object of the present invention is to provide an Improved Timekeeping and Recording System that is provided with a method to display the value of any given Slip in a variety of currencies including currencies by region or country or groups of countries, such as the EU.

In addition, another primary object of the present invention is to provide an Improved Timekeeping and Recording System which is provided with a method to flag duplicate slips and excessive hours charged to a client (more than 8 per day, or 12 per day, or 180 per month or 2,000 per year), so as to satisfy ethical concerns and practices of overbilling clients.

Still an primary object of the present invention is to provide an Improved Timekeeping and Recording System which is provided with means for automating confidentiality of the time recorded by one or more of the following: a list of individuals, groups of billing entities, levels of employees (lawyers, paralegals, law clerks, secretaries, staff, administrators), or local work groups versus global.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a detailed flow chart of the present inventive system, Improved Time Entry and Recording System.

FIG. 2 is a detailed flow chart of the present inventive system, Improved Time Entry and Recording System.

FIG. 3 is a screen shot of the present invention when used in mobile app format.

FIG. 4 is a screen shot of the present invention when used in mobile app format.

FIG. 5 is a screen shot of the present invention when used in mobile app format.

FIG. 6 is a screen shot of the present invention when used in mobile app format.

FIG. 7 is a screen shot of the present invention when used in mobile app format.

FIG. 8 is a screen shot of the present invention when used in mobile app format.

### DETAILED DESCRIPTION OF THE DRAWINGS

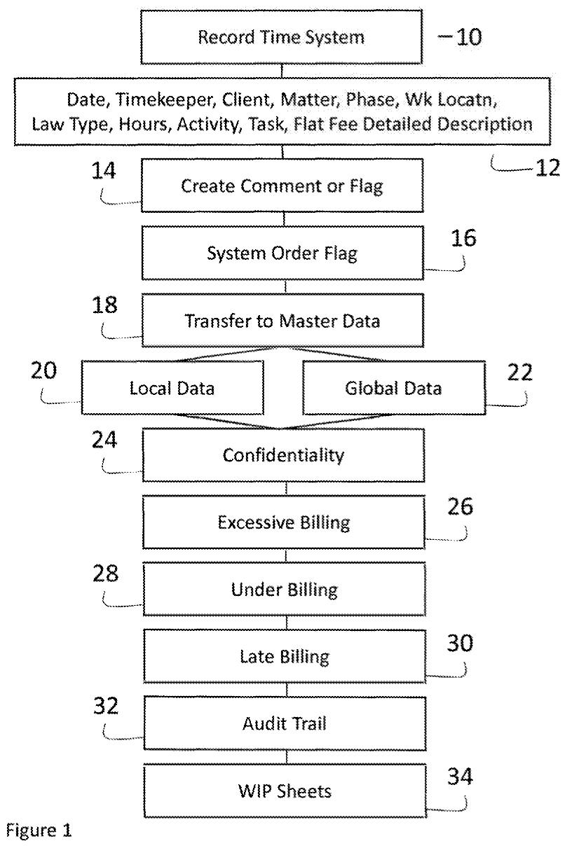

FIG. 1 is a flow chart of the present invention, Improved Time Entry and Reporting System and Method showing the initial phase of the Improved System, the portion that records the time an analyzes it for errors, or Improved Time Recording System 10 which is initialized by the User thereof by first inputting some or all of the following Time related data entries: Work Date, Timekeeper, Client, Matter, Phase, Work Location, Law Type, Hours, Activity, Task, Flat Fee and Detailed Description or Narrative 12. In this part of the Time entry phase, the Date is the date upon which the work is done. In practice, the present inventive System, Improved Time Entry and Reporting, will also keep track of the Date when the time is entered, to ensure Time Entries are not submitted in advance of billed time, nor is there an unsuitable time lag between when the Time has been charged and the date that time is input into the present inventive Time Entry and Reporting System 10.

The Client field may be assigned an actual name, a nickname and/or a numeric code which is stored in the System 10. Next, the User will be provided with, or may create a billable Matter, which may be accessed by a name, nickname and/or numeric code which is stored in System 10. Examples of a billable Matter may include: Smith v. Jones; In re Estate of Doe; the name of a patent or trademark, the name of a building being bought or sold, etc. In addition, the Work Location is input into the System 10 and it can also be stored by name, nickname and/or numeric code. Next, the User may submit the hours she or he has spent on a particular matter and the System 10 may record the hours in two different formats; namely, either as a decimal format (1.25 for one hour 15 minutes; 1.50 for one hour 30 minutes, etc.) or in hours and minutes (1:15 for one hour 15 minutes; 1:30 for one hour 30 minutes, etc.) as desired by the user. Next, the User will input the type of Activity undertaken for the client. Typical examples include: litigation, prosecution, transactional work, mediation, etc. The User can then input the type of Task involved in the work performed such as: meeting at firm, meeting at client, phone conversation, email, drafting documents, drafting pleadings, court appearance, etc. Finally, the User will provide a detailed description of the work performed which will induce a client to pay the bill. For example: preparing survey, water bill and other documents for closing; drafting Office Action response to USPTO; meeting with client in the office regarding estate planning. In such a manner, a firm can keep track of the most profitable and popular tasks, which its attorneys and billing entities engage in during their time at the firm.

Next, the User while entering time will be able to create a comment or flag by clicking on an icon next to any field on the screen 14. For example, the User may wish to check time on a particular matter and so she or he will flag the Time box and/or put in a comment as a reminder to later check that field. In addition, the System itself can automatically generate flags when time is entered incorrectly according to a pre-determined set of rules or algorithms 16.

After the time has been flagged, comments added and checked by the system for any errors, then at a predetermined time, it may be uploaded into a Master Data System 18 which is accessible on a local 20 and global data 22 basis. At this stage, the Time Entry Date may be checked against a confidentiality check list 24 so that it is selectively available to individuals or groups of entities according to the Billing Partner or Client Originating Attorney. At this point, the System 10 can check for any excessive billing practices 26, under billing issues 28 and/or late billing problems 30. In the case of excessive billing practices 26, the present inventive system may provide checks by day, week, month and/or year. In general, attorneys may not charge clients more than 8 to 12 hours per day, or 60 hours per week, or 180 to 200 hours per month or over 2200 hours per year, or it may create liability to the firm, and/or an ethics violation to the attorney.

Similarly, late billing 30 may create a problem for the firm in that time records may not be timely generated and recorded, indicating the attorney may be fabricating time, or the time is incorrect. In addition, under billing 30 flags may indicate an illness, a family problem or issue or another condition that may be remedied by quick assistance to the attorney before it becomes a major employment issue. By utilizing such tabs and controls, the firm may produce a more efficient and profitable entity.

In addition, the present inventive Time Entry System 10 may be provided with an audit trail 32 that keeps track of all time changes, when they occurred, and by whom they occurred. The Time Entry System 10 can then keep track of changes that indicate an attorney habitually writes off time or increases time artificially after the fact. Time that is written off is charged against the attorney. Time that is increased sometime after the date it was allegedly performed can be accumulated in the Master Data base for further review by a Billing Partner or Client Originator.

Finally, WIP or Work in Process sheets 34 may be generated by the System 10 for the Billing Entity, the Billing Partner, the Client Originator and staff and administration as the confidentiality controls of the System 10 permit. These are WIP sheets that may be edited in real time, both locally and globally. Both the WIP sheets and the Work Data Summaries may display the time billed or billable value in three currencies, namely, local, matter and billing taking into account different exchange rates. The calculations are automatic and in real time. They may be automatically gleaned from a wide variety of continually updated websites, such as the Wall Street Journal, the New York Times and other mainstream media which tracks currency exchange rates around the world. In addition, the Work Data Summaries List or WIP may display a number of lines preselected by the user. In such a manner a Data Entry Listing may comprise just one line of data for a matter being billed, or it might comprise 2 or more lines of data for matters being billed.

In one preferred embodiment of the present inventive system, the WIP reports and time and disbursement entries may be monitored and displayed all around the globe in one Master Data system and report, updated in real time for current exchange rates. This may include hundreds of thousands of entries for large firms operating around the world in dozens of countries, which are entered daily and calculated continuously in real time.

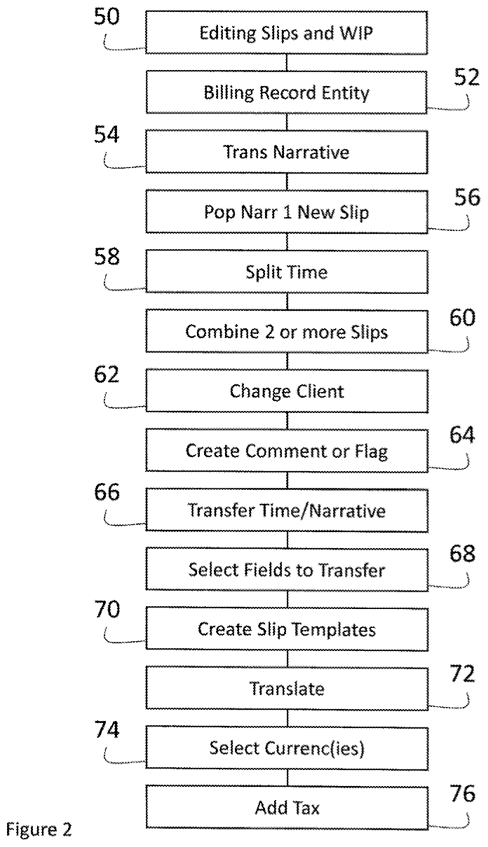

FIG. 2 shows a flow chart of the present inventive system for Editing Slips and Generating a WIP 50. This present inventive System for Generating a WIP 50 begins with recording a Billing Entry 52 which consists at a minimum of: entering the date of the work performed, the name of the billing entity or Timekeeper, the name of the Client or nickname, the Matter involved, the time spent on the matter, and the Detailed Description or Narrative. Other fields may include the Law Type (patents, contracts, trademarks, litigation, etc.), the Activity, the Task performed, a Flat Fee setting above which no billing can be charged, etc.

Next are shown the various manipulations of data which the System 50 may make with the data entered into a billing entry. The System 50 may transfer a Detailed Description or Narrative 54 from one Time Entry to another effectively overwriting the second Time Entry. Or, the System 50 may create a new slip with a duplicate Narrative 56. In addition, the System 50 may take one Time Entry and split it into two Time Entries or more, with the User thereof determining the amount of time for each Time Entry involved 58. In addition, one or more Time Entries may be marked so that they may be combined together 60 into one new Time Entry, and the User will select which fields will appear in the new combined Time Entry that survives this action.

In addition, the User will be allowed to change the Client, Matter, Activity, Phase, Work Location, Law Type, Hours, etc. for any particular Time Entry 60 prior to upload into the Master Data base. At this point, the User may also create additional comments or Flags on any Time Entry so that they may be reviewed at a later date 64. A further feature of the present inventive System 50 allows the User thereof to select some or all field to transfer from one Time Entry to a second Time Entry 66, 68, effectively overwriting the said data.

An additional feature of the present inventive System 50 is to allow the User to create both abbreviations to shorten typing tasks, and to allow the User to create Slip Templates 70 according to the Matter for that particular client. For example, the User may be typing over and over for a particular Matter: Timekeeper, Detailed Description, Phase, Location, Law Type, Activity, Task and only changing the date and the time. By creating Matter templates, this will greatly shorten the typing load for a particular Timekeeper or Billing Entity.

In addition, at any stage, from Time Entry creation 52 to generating a WIP, the System 50 will be capable of spell checking and translating 72 the Detailed Description by simply choosing the task from a pull down menu or button on the screen. Similarly, the System 50 will create a Value Field for each Time Entry on a screen, and this Value Field will be able to be displayed by the user in one to three currencies 74. Typical types of currency display may be by the country, a local currency, a group of countries such as the EU, or currencies found only on the internet, such as Bitcoin and the like.

Finally, the present inventive system 50 will be able to generate pre bills or WIP sheets that will create a value for taxes 76 which are either from predetermined tables, or which can be downloaded directly from internet sources in near real time, such as the Wall Street Journal, the New York Times and the like. In such a manner, local taxes, county taxes, city and municipality taxes and even VAT or Value Added Tax can be calculated and displayed in the WIP format. After each of the foregoing steps have been realized in the System 50, the User will be able to create a WIP sheet displayed in the Improved Billing System in which any of the fields involved may be edited and stored in near real time: Date of Work, Timekeeper Name, Client Name, Matter, Phase, Work Location, Law Type, Hours, Activity, Task, Flat Fee data and Detailed Description or Narrative.

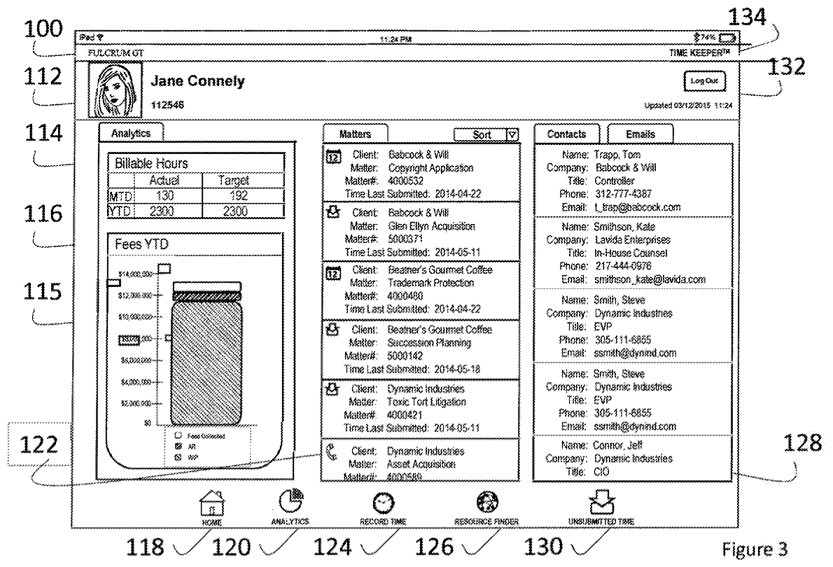

FIG. 3 shows a screen shot of a mobile app version of the present invention, Improved Time and Billing System 100 wherein are displayed on the screen display unit 115 the Timekeeper 112 together with a numeric identifier and name and picture; the total billable hours 114 by actual and by target, by month and by date; the Fees billed and collected, Year to Date 116 in bar column format; buttons are provided to access other portions of the Improved Time and Billing System 100, namely: Home page 118, Analytics section 120; Record Time 124; Resource Finder 126 and Unsubmitted Time 130. The screen display unit 115 also provides for a log out option 132 and it allows the user to change Timekeeper 134.

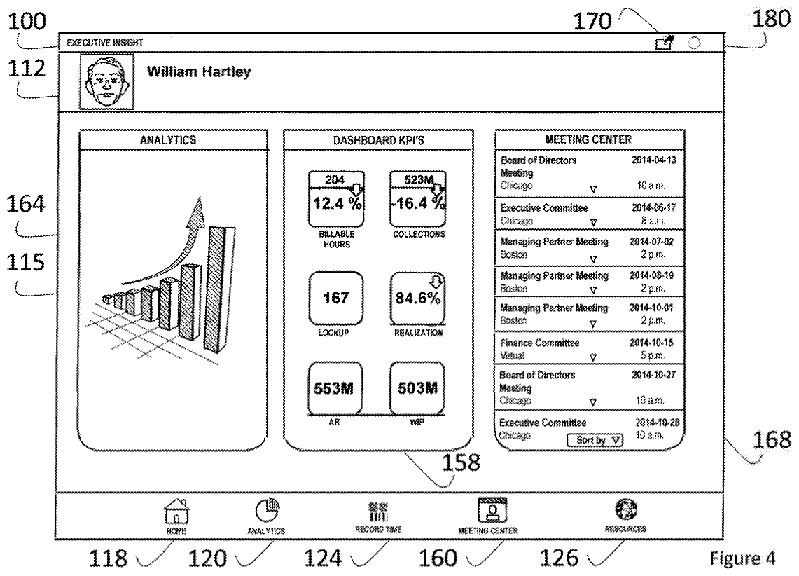

FIG. 4 shows an alternate screen shot of an alternate version of the present invention, Improved Time and Billing System 100 wherein are displayed on the screen display unit 115 the Timekeeper 150, the Billing Analytics in 3-D bar graph format, the Dashboard Key Performance Indicators (KPI) indicating the billable hours, collections, lock up, a realization figure consisting of analytics and accounts receivables figure and a WIP or Work in Progress figure. The screen display unit 115 also displays the Home icon 154, an Analytics icon 156, a Dashboard Icon 158, a Meeting Center icon 160 and a Resources icon 162 to take the user to additional system resources. Further provided are a breakout icon to share page through email, text, twitter or other means 170 and a Settings icon 180.

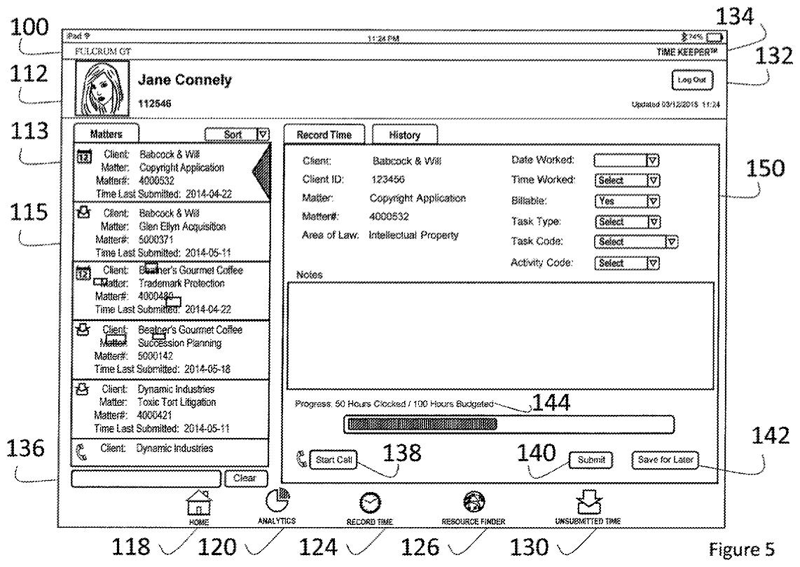

FIG. 5 shows yet another alternate screen shot of an alternate version of the present invention, Improved Time and Billing System 100 wherein are displayed on the screen display unit 115 the following items of interest: a summary of Matters 113, which are sortable by the user thereof, generally Timekeeper 112 via a search field 136; Icons for Home 118, Analytics 120, Recording Time 124, Resource Finder 126 and Unsubmitted Time 130 to take the user to these screen apps, as desired. This screen shot also shows the area where the user may easily enter his or her time 150 and fields are available for Client, Client ID number, the Matter, the Matter #, the Area of Law, the Date worked, the Time worked, whether the Time recorded is billable or not, the Task type, the Task coding, the Activity code and of course Notes on the billing being entered. There is also provided a bar chart for progress consisting of the hours clocked versus the hours budgeted 144. In addition, there is a Start Call icon 138 which will initiate a phone call which may be audio only or it may be Skyped. Further, the user will be able to immediately Submit time entered via Icon 140, or she or he may Save for Later via Icon 142.

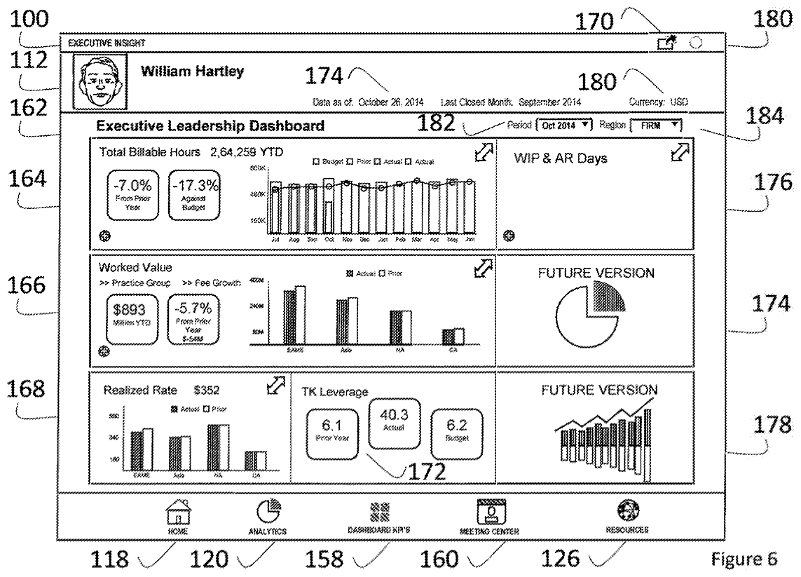

FIG. 6 comprises a screen shot version of the present invention, improved Timekeeping and Billing System 100 which shows the following fields: Timekeeper 112, Report Name 162, Billable Hours report 164 in numeric and bar chart form, Work Value 166 in numeric and bar chart form; the Realized Rate in bar chart form 168, the Timekeeper Leverage, that is the hours of non-equity partner worked per equity partner or (partner time vs non partner time), expressed in a ratio format, in floating icon format 172, areas are also provided for Future Versions 174 and 178 and data may be display for WIP and AR Days 176. In addition, the Report Date is displayed, as is the Currency 181, the Period 182, the Region 184 and the breakout icon to share page through email, text, twitter or other means 170 and settings 180.

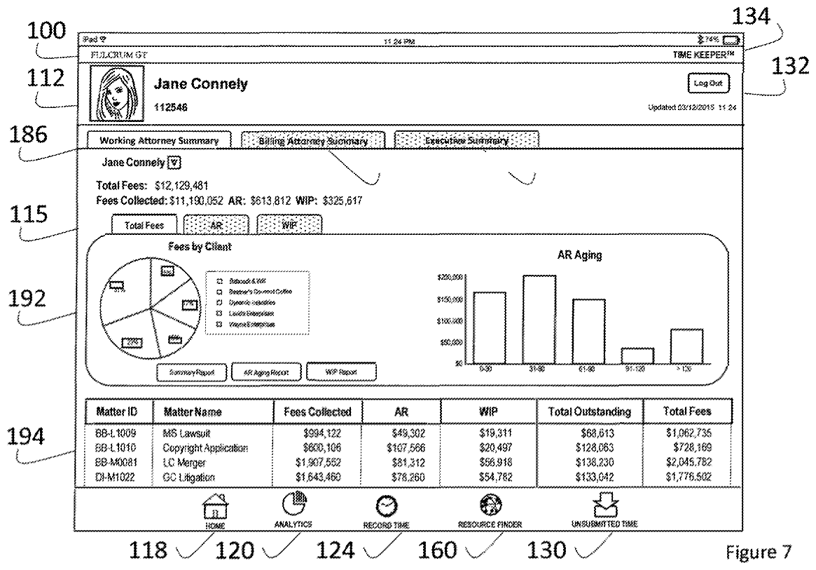

FIG. 7 shows a further screen shot of present invention, Improved Timekeeping and Billing System 100 which displays on display unit 115 the following items: the Timekeeper 112, a pie chart for Fees by Client 192 together with an AR or Accounts Receivables bar chart, a Billing Data Summary entry listing 194 and Icons to go to other portions of the Improved Timekeeping and Billing System 100, namely, Home icon 118, Analytics icon 120; Record Time icon 124; Resource Finder 160 and Unsubmitted Time 130. In addition, the Logout Icon 132 icon is displayed and the change Timekeeper Icon 134 is accessible by the user thereof.

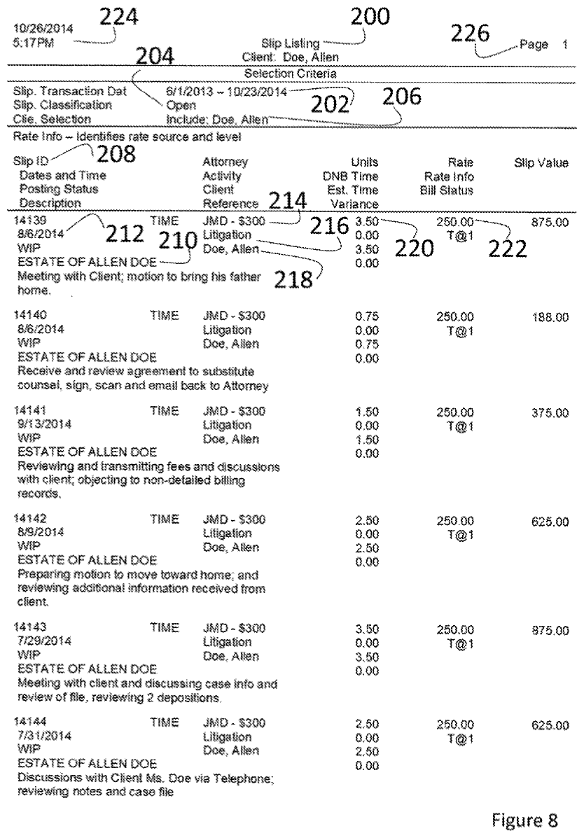

Shown now In FIG. 8, is one preferred embodiment of the present invention, Improved Timekeeping and Billing System, showing an editable Work Data Summary Listing 200. In this particular embodiment of the present inventive billing and timekeeping system, the Work Data Summaries have been listed by Client 206, and they have been sorted according to Client 206, though it is possible to sort by date 212 as well. In this particular view, it is possible to edit directly on the Work Data Summary Listing 200 each of: date 212; the narrative 210; the timekeeper 214, the activity 216, the client 218, the hours spent 220 and the rate of the timekeeper 222. This can be done directly on the electronic display screen in real time. The user can also select all active, non billed slips, or those which are open 204. The user can also select the time period, in this case Jun. 1, 2013 through Oct. 23, 2014, or any period as desired. The header gives the date and time the listing was created 224. Page numbers 226 also help the attorney, timekeeper or staff member while editing the Work Data Summary listing 200.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

1-13. (canceled)

14. A computer system configured to process time-entry data from a plurality of computer devices, the computer system comprising:
a master database accessible to the plurality of computer devices; and
an application server comprising a processing device and a non-transitory storage medium for storing instructions that when executed by the processing device cause the processing device to:
receive a first time entry comprising time-entry data including timekeeper and work date from one of the plurality of computer devices;
receive a second time entry comprising time-entry data including the timekeeper and the work date from one of the plurality of computer devices;
store at least one of the first time entry and the second time entry in the master database;
analyze the time-entry data in real time according to a predetermined set of rules, the predetermined set of rules including a rule that combines time entries and a rule that prevents the time-entry data from exceeding a predetermined number of hours;
automatically combine the first time entry and the second time entry based on the timekeeper and the work date to create a combined time entry comprising combined time-entry data including the timekeeper and the work date and overwrite the at least one of the first time entry and the second time entry with the combined time entry in the master database;
automatically overwrite the combined time-entry data with corrected time-entry data when an error is detected according to the predetermined set of rules; and
create a work-in-progress report in real time using the corrected time-entry data.

15. The computer system of claim 14, wherein those executable instructions that, when executed by the processing device, analyze the time-entry data for errors in real time are further operative to automatically generate a flag when an error is detected.

16. The computer system of claim 14, wherein the time-entry data further includes one or more of: matter name, work location, time spent on a matter, task, and work performed.

17. The computer system of claim 14, which is configured to automatically correct an error corresponding to any one of: incorrect date, excessive billing, under billing, and late billing.

18. The computer system of claim 17, wherein excessive billing corresponds to an excess number of hours billed for a matter during a set period, including day, week, month, or year;
wherein the excess number is determined in accordance with a set of user-defined rules or the hours available in the set period.

19. The computer system of claim 14, the storage medium further comprising executable instructions that, when executed by the processing device, cause the processing device to:
track the number of times the time-entry data is changed during a given time;
generate a pattern from the changed time-entry data; and
generate an audit trail, associating the pattern with a user identification corresponding to the time entry data.

20. The computer system of claim 14, the storage medium further comprising executable instructions that, when executed by the processing device, cause the processing device to:
access at least one exchange rate from a third party website;
calculate a billable value for the corrected time entry data using the at least one exchange rate; and
display the work-in-progress report with the billable value.

21. The computer system of claim 14, the storage medium further comprising executable instructions that, when executed by the processing device, cause the processing device to:
access a plurality of exchange rates from at least one third party website;
calculate a plurality of billable values for the corrected time entry data using each of the plurality of exchange rates; and
display the work-in-progress report with the plurality of billable values.

22. A method for processing time-entry data in an application server in communication with a master database accessible to a plurality of computer devices, the method comprising:
receiving, by the application server, a first time entry comprising time-entry data including timekeeper and work date from one of the plurality of computer devices;
receiving, by the application server, a second time entry comprising time-entry data including the timekeeper and the work date from one of the plurality of computer devices;
storing, by the master database, at least one of the first time entry and the second time entry;
analyzing, by the application server, the time-entry data in real time according to a predetermined set of rules, the predetermined set of rules including a rule that combines time entries and a rule that prevents the time-entry data from exceeding a predetermined number of hours;
automatically combining, by the application server, the first time entry and the second time entry based on the timekeeper and the work date to create a combined time entry including combined time-entry data including the timekeeper and the work date and overwriting the at least one of the first time entry and the second time entry with the combined time entry in the master database;
automatically overwriting, by the application server, the combined time-entry data with corrected time-entry data when an error is detected according to the predetermined set of rules; and
creating, by the application server, a work-in-progress report in real time using the corrected time-entry data.

23. The method of claim 22, wherein the time-entry data further includes one or more of: matter name, work location, time spent on a matter, task, and work performed.

24. The method of claim 22, further comprising
automatically generating a flag when an error is detected in the time-entry data.

25. The method of claim 24, wherein the error corresponds to any one of:
incorrect date, excessive billing, under billing, and late billing.

26. The method of claim 25, wherein excessive billing corresponds to an excess number of hours billed for a matter during a set period, including day, week, month, or year;
wherein the excess number is determined in accordance with a set of user-defined rules or the hours available in the set period.

27. The method of claim 22, further comprising:
tracking, by the application server, the number of times the time-entry data is changed during a given time;
generating, by the application server, a pattern from the changed time-entry data; and
generating, by the application server, an audit trail associating the pattern with a user identification corresponding to the time-entry data.

28. The method of claim 22, further comprising:
generating, by the application server, a value field that corresponds to the time-entry data;
associating, by the application server, taxes to the value field that corresponds to the time-entry data;
wherein the taxes include local taxes, county taxes, municipal taxes or value-added taxes and are determined in accordance with a set of user-defined rules.

29. The method of claim 22, further comprising:
accessing at least one exchange rate from a third party website;
calculating a billable value for the corrected time entry data using the at least one exchange rate; and
displaying the work-in-progress report with the billable value.

30. The method of claim 22, further comprising:
accessing a plurality of exchange rates from at least one third party website;
calculating a plurality of billable values for the corrected time entry data using each of the plurality of exchange rates; and
displaying the work-in-progress report with the plurality of billable values.
